(19) United States
(12) Patent Application Publication
(10) Pub. No.: US 2018/0101770 A1
(43) Pub. Date: Apr. 12, 2018

(54) METHOD AND SYSTEM OF GENERATIVE MODEL LEARNING, AND PROGRAM PRODUCT

(71) Applicants: Takuya TANAKA, Kanagawa (JP); Yusuke KANEBAKO, Miyagi (JP)

(72) Inventors: Takuya TANAKA, Kanagawa (JP); Yusuke KANEBAKO, Miyagi (JP)

(73) Assignee: Ricoh Company, Ltd., Tokyo (JP)

(21) Appl. No.: 15/716,558

(22) Filed: Sep. 27, 2017

(30) Foreign Application Priority Data
Oct. 12, 2016 (JP) 2016-200527

(51) Int. Cl. G06N 3/08; G06N 3/04

(52) U.S. Cl. CPC G06N 3/088; G06N 3/0454

(57) ABSTRACT

A generative model learning method includes learning a first generative model by unsupervised learning based on train data prepared beforehand, generating generated data by the first generative model, and learning a second generative model by supervised learning based on the train data and the generated data determined as undesirable by a user.

### CROSS-REFERENCE TO RELATED APPLICATIONS

This patent application is based on and claims priority pursuant to 35 U.S.C. § 119(a) to Japanese Patent Application No. 2016-200527, filed on Oct. 12, 2016, in the Japan Patent Office, the entire disclosure of which is hereby incorporated by reference herein.

### BACKGROUND

### Technical Field

The present invention relates to a generative model learning system, generative model learning method, and computer program product.

### Description of the Related Art

Conventionally in a field of artificial intelligence, a generative model has been used. The generative model can learn a model of a data set to generate data similar to train data included in the data set.

In recent years, a generative model has been devised that uses deep learning such as a Variational Auto Encoder (VAE) and Generative Adversarial Networks (GANs). These generative models are referred to as deep generative models, and capable of generating the data similar to the train data with higher accuracy in comparison with a conventional generative model.

However, in the conventional deep generative model, it has been difficult to control the data to be generated, so that data undesirable to a user may have been generated.

### SUMMARY

Example embodiments of the present invention include a generative model learning method including learning a first generative model by unsupervised learning based on train data prepared beforehand, generating generated data by the first generative model, and learning a second generative model by supervised learning based on the train data and the generated data determined as undesirable by a user.

Example embodiments of the present invention include a generative model learning system, which causes one or more processors to learn a first generative model by unsupervised learning based on train data prepared beforehand, generates generated data by the first generative model, and learns a second generative model by supervised learning based on the train data and the generated data determined as undesirable by a user.

Example embodiments of the present invention include a computer program product such as a non-transitory recording medium causing a computer to perform the above-described generative model learning method.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a functional configuration of a generative model learning device;

FIG. 2 is a diagram illustrating an example of a hardware configuration of the generative model learning device;

FIG. 3 is a diagram schematically illustrating a configuration of a first generative model (Deep Convolutional GAN (DCGAN)) in a first embodiment;

FIG. 4 is a flowchart illustrating a learning process of the first generative model in the first embodiment;

FIG. 5 is a diagram schematically illustrating a configuration of a second generative model (Blacklist DCGAN (BDCGAN)) in the first embodiment;

FIG. 6 is a flowchart illustrating a learning process of the second generative model in the first embodiment;

FIG. 7 is a flowchart illustrating an example of a learning process executed by a generative model learning device according to the first embodiment;

FIGS. 8A and 8B (FIG. 8) are a diagram illustrating an example of a structure of each of discriminators of the first generative model and the second generative model in the first embodiment;

FIG. 9 is a diagram schematically illustrating a configuration of a second generative model (CGAN) in a second embodiment;

FIG. 10 is a flowchart illustrating a learning process of the second generative model in the second embodiment;

FIG. 11 is a flowchart illustrating an example of a learning process executed by a generative model learning device according to the second embodiment;

FIGS. 12A and 12B (FIG. 12) are a diagram illustrating an example of a structure of each of discriminators of a first generative model and the second generative model in the second embodiment; and

FIGS. 13A and 13B (FIG. 13) are a diagram illustrating an example of a structure of each of generators of the first generative model and the second generative model in the second embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, embodiments of the present invention will be described referring to the accompanying drawings. Regarding descriptions of the drawings and the specification according to the embodiments, constituents having substantially the same functional configuration will be denoted by the same reference numerals, and redundant description will be omitted.

### First Embodiment

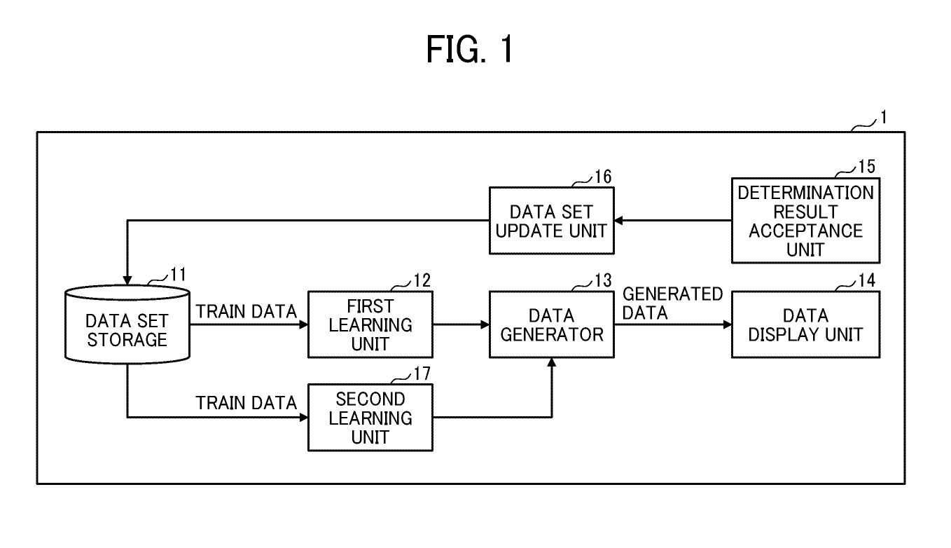

A generative model learning device 1 (hereinafter, referred to as a “learning device 1”) according to a first embodiment will be described referring to FIGS. 1 to 8. First, a functional configuration of the learning device 1 will be described. FIG. 1 is a diagram illustrating an example of a functional configuration of the learning device 1. The learning device 1 of FIG. 1 includes a data set storage 11, a first learning unit 12, a data generator 13, a data display unit 14, a determination result acceptance unit 15, a data set update unit 16, and a second learning unit 17.

The data set storage 11 stores a data set prepared beforehand by a user. The data set is a set of a plurality of train data, and is used for learning of a first generative model and a second generative model described later. The train data can be image data, text data, or video data. In the following, it is assumed that the train data is the image data. A label indicating that the data is the train data is given to each of the train data. Hereinafter, the label given to the train data is referred to as an original class.

The first learning unit 12 learns the first generative model by unsupervised learning on the basis of some or all of the train data included in the data set. Learning the first generative model means learning values of parameters included in the first generative model. The first generative model is a GAN including a generator and a discriminator. The generator generates data similar to the train data. The data generated by the generator is referred to as generated data. The discriminator discriminates between the generated data and the train data. The generator and the discriminator each include a multilayered neural network. The GAN and the first generative model will be described in detail later.

In the present specification, the unsupervised learning means learning using data for learning not including teacher data. Supervised learning means learning using data for learning including the teacher data.

The data generator 13 inputs an input variable (latent variable) to the first generative model learned by the first learning unit 12 and the second generative model described later, thereby generating a plurality of generated data. Also, the data generator 13 gives a label indicating that the data is the generated data, to the generated data. Hereinafter, the label given to the generated data is referred to as a generated class.

The data display unit 14 causes a display device 106 described later to display the generated data generated by the data generator 13.

The user confirms the image data displayed on the display device 106, thereby determining whether each of the generated data is desirable. The user, when determining that the generated data is sufficiently similar to the train data, determines that the generated data is desirable. That is, desirable generated data has a degree of similarity to the train data corresponding to the generated data satisfying a user's request. On the other hand, the user, when determining that the generated data is not sufficiently similar to the train data, determines that the generated data is undesirable. That is, undesirable generated data has a degree of similarity to the train data corresponding to the generated data not satisfying the user's request.

For example, a case is considered where the train data is image data of a handwritten character. In this case, the first generative model generates image data similar to the image data of the handwritten character as the generated data. In a case where the image data generated by the first generative model is readable as the handwritten character, the user determines that the image data is desirable. On the other hand, in a case where the image data generated by the first generative model is not readable as the handwritten character, the user determines that the image data is undesirable.

The determination result acceptance unit 15 accepts a determination result by the user for each of the generated data generated by the first generative model or the second generative model.

The data set update unit 16 updates the data set based on the determination result for each of the generated data accepted by the determination result acceptance unit 15. Specifically, the data set update unit 16 adds the generated data determined as undesirable by the user, to the data set. At this time, the data set update unit 16 gives a label indicating that the data is the generated data determined as undesirable, to the generated data added to the data set. Hereinafter, the label given to the generated data determined as undesirable is referred to as a black list class. The generated data to which the black list class is given is referred to as black list data.

The second learning unit 17 learns the second generative model by supervised learning based on data for learning including the black list data (teacher data) and some or all of the train data included in the data set. Learning the second generative model means learning values of parameters included in the second generative model. As parameters of the second generative model, parameters of the first generative model learned are inherited. The second generative model is a GAN including a generator and a discriminator. The generator generates data similar to the train data. The data generated by the generator is referred to as generated data. The discriminator discriminates between the generated data and the train data. The generator and the discriminator each include a multilayered neural network. The GAN and the second generative model will be described in detail later.

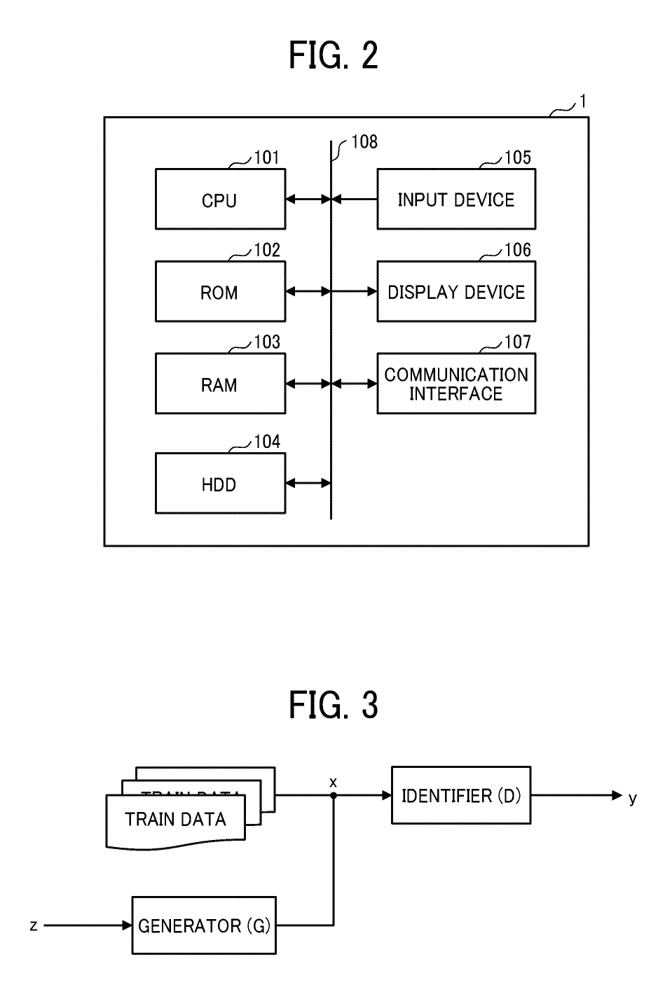

Next, a hardware configuration of the learning device 1 will be described. The learning device 1 includes a computer such as a server computer or a client computer. FIG. 2 is a diagram illustrating an example of the hardware configuration of the learning device 1. The learning device 1 of FIG. 2 includes a central processing unit (CPU) 101, read only memory (ROM) 102, random access memory (RAM) 103, and a hard disk drive (HDD) 104. Also, the learning device 1 includes an input device 105, the display device 106, a communication interface 107, and a bus 108.

The CPU 101 executes a program, thereby controlling each constituent of the learning device 1 to realize a function of the learning device 1. The ROM 102 stores various data including the program executed by the CPU 101. The RAM 103 provides a work area for the CPU 101. The HDD 104 stores various data including the data set and the program executed by the CPU 101. The input device 105 inputs information according to operation by the user, to the learning device 1. The input device 105 can be a mouse, a keyboard, a touch panel, or a hardware key. The input variable and the determination result may be input by operation of the input device 105. The display device 106 displays various data including the generated data. The display device 106 can be a liquid crystal display, an organic electro luminescence (EL) display, or a cathode ray tube display. The communication interface 107 is an interface for connecting the learning device 1 to a network such as a local area network (LAN) or the Internet. The learning device 1 communicates with an external device via the communication interface 107. The input variable and the determination result may be input from the external device via the communication interface 107. The bus 108 connects the CPU 101, the ROM 102, the RAM 103, the HDD 104, the input device 105, the display device 106, and the communication interface 107 to each other. Incidentally, in the example of FIG. 2, the learning device 1 includes a single computer, but may be a system including a plurality of computers connected to each other via the network.

Next, the GAN, the first generative model, and the second generative model will be described in detail. As described above, the GAN is a kind of the deep generative model, and includes the generator and the discriminator. In the present embodiment, as the GAN included in the first generative model and the second generative model, a Deep Convolutional GAN (DCGAN) is used. The DCGAN is a GAN using a Convolutional Neural Network (CNN), and includes a plurality of layers.

In the present embodiment, the first generative model includes the DCGAN. The first learning unit 12 learns the first generative model on the basis of the train data stored in the data set storage 11 and the generated data generated by the generator.

FIG. 3 is a diagram schematically illustrating a configuration of the first generative model (DCGAN) in the present embodiment. In FIG. 3, x represents an input variable (train data and generated data) input to the discriminator, y represents an output variable (original class and generated class) output by the discriminator, and z represents an input variable (latent variable) input to the generator. D represents a parameter group included in the discriminator, and G represents a parameter group included in the generator. The parameter groups D and G each include a plurality of parameters.

The discriminator of the first generative model is learned to be able to discriminate whether the input variable x is the train data or the generated data. Specifically, the parameter group D is learned such that the output variable y is the original class in a case where the input variable x is the train data, and the output variable y is the generated class in a case where the input variable x is the generated data.

In contrast, the generator of the first generative model is learned to be able to generate the generated data that cannot be discriminated from the train data by the discriminator. Specifically,the parameter group G is learned such that the output variable y is the original class in a case where the generated data is input as the input variable x to the discriminator.

The first learning unit 12 repeats learning described above of the first generative model. Thus, discrimination accuracy of the discriminator improves, and generation accuracy by the generator (degree of similarity of the generated data to the train data) improves. The learning described above of the first generative model is realized by solving the following evaluation function.

$$\begin{matrix}[ Mathematical Equation 1 ] & \\ {min}_{G} {max}_{D} V ( D , G ) = {E}_{x \text{\textasciitilde} pdata ( x )} [ log D ( x ) ] + {E}_{z \text{\textasciitilde} pz ( z )} [ log ( 1 - D ( G ( z ) ) ) ] & ( 1 )\end{matrix}$$

In Equation (1), V corresponds to an evaluated value, E[·] corresponds to an expected value, and x˜pdata corresponds to a set (input variable x) of the train data sampled from the data set. Also, z˜pz corresponds to the input variable z, D(x) corresponds to the output variable y in a case where the input variable x is input, and G(z) corresponds to the generated data in a case where the input variable z is input.

The first term on the right side of Equation (1) corresponds to an evaluated value of the discriminator, and has a higher value as the discrimination accuracy of the discriminator is higher. The second tern on the right side of Equation (1) corresponds to an evaluated value of the generator, and has a higher value as the degree of similarity of the generated data to the train data is higher (as erroneous discrimination of the discriminator is increased).

As can be seen from the above, as learning of the discriminator progresses, the first term on the right side of Equation (1) increases, and the second term on the right side decreases. Also, as learning of the generator progresses, the first term on the right side of Equation (1) decreases, and the second term on the right side increases.

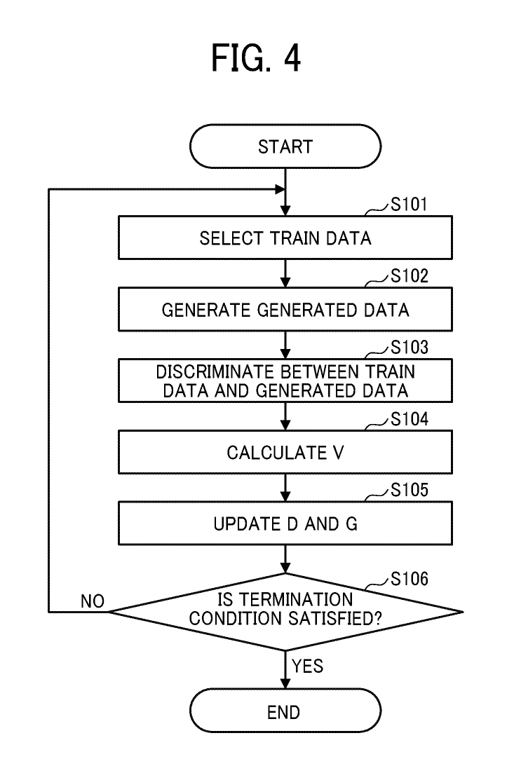

FIG. 4 is a flowchart illustrating a learning process of the first generative model by the first learning unit 12. First, the first learning unit 12 selects some or all of the train data included in the data set (step S101). Next, the first learning unit 12 generates the generated data by the generator on the basis of the input variable z (step S102). The generated data is input to the discriminator as the input variable x. Subsequently, the first learning unit 12 discriminates between the train data selected in step S101 and the generated data generated in step S102, by the discriminator (step S103). Then, the first learning unit 12 calculates the evaluated value V on the basis of a discrimination result (step S104). After that, the first learning unit 12 updates the parameter groups D and G on the basis of the evaluated value V (step S105). Afterwards, the first learning unit 12 repeats the processing from step S101 to step S106 until a termination condition is satisfied. The termination condition may be set by the number of times of the learning process, and may be set by the evaluated value V or the evaluated values E of the discriminator and the generator. When the termination condition is satisfied (YES in step S106), the learning process ends.

As described above, the first learning unit 12 learns the first generative model on the basis of the train data and the generated data. In contrast, the second learning unit 17 learns the second generative model on the basis of the train data, the generated data, and the black list data (generated data determined as undesirable). In the present embodiment, a DCGAN included in the second generative model is referred to as a Blacklist DCGAN (BDCGAN).

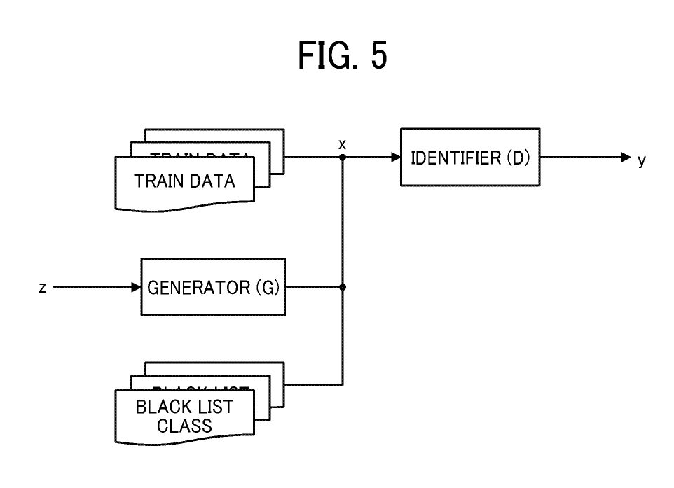

FIG. 5 is a diagram schematically illustrating a configuration of the second generative model (BDCGAN) in the present embodiment. In FIG. 5, x represents an input variable (train data, generated data, and black list data) input to the discriminator, and y represents an output variable (original class, generated class, and Hack list class) output by the discriminator. Also, z represents an input variable (latent variable) input to the generator, D represents a parameter group included in the discriminator, and G represents a parameter group included in the generator. The parameter groups D and G each include a plurality of parameters.

The discriminator of the second generative model is learned by supervised learning to be able to discriminate whether the input variable x is the train data, the generated data, or the black list data. Specifically, the parameter group D is learned such that the output variable y is the original class in a case where the input variable x is the train data, and the output variable y is the generated class in a case where the input variable x is the generated data. Also, the parameter group D is learned such that the output variable y is the black list class in a case where the input variable x is the black list data.

In contrast, the generator of the second generative model is learned by supervised learning to be able to generate the generated data that cannot be discriminated from the train data by the discriminator, and not to generate the generated data similar to the black list data. Specifically, the parameter group G is learned such that, in a case where the generated data is input as the input variable x to the discriminator, the output variable y is the original class and is not the black list class.

The second learning unit 17 repeats learning described above of the second generative model. Thus, discrimination accuracy of the discriminator improves, and generation accuracy by the generator (degree of similarity of the generated data to the train data) improves. Also, generation of the black list data can be suppressed. The learning described above of the second generative model is realized by solving the following evaluation function.

$$\begin{matrix}[ Mathematical Equation 2 ] & \\ {min}_{G} {max}_{D} V ( D , G ) = {E}_{x \text{\textasciitilde} pdata ( x )} [ {L}_{data} log D ( x ) ] + {E}_{z \text{\textasciitilde} pz ( z )} [ {L}_{gen} log ( G ( z ) ) ] + {E}_{x \text{\textasciitilde} pblacklist ( x )} [ {L}_{blacklist} log D ( x ) ] & ( 2 )\end{matrix}$$

In Equation (2), x˜pblacklist represents a set (input variable x) of black list data sampled from the entire black list data, and L represents a vector corresponding to a label (correct solution data) given to the data. In a case of the present embodiment, L is a three-dimensional vector since there are three types of labels, and for example. L_data, L_gen, and L_blacklist can be expressed as [1 0 0], [0 1 0], and [0 0 1], respectively. Equation (2) is different from Equation (1) in two points.

The first point is that the discriminator discriminates the data into three types of original class, generated class, and black list class. The second point is that, in a case where the discriminator determines that the label of the generated data is the black list class, loss of the discriminator occurs, and the evaluated value V decreases. With the evaluation function of Equation (2), the parameters of the generator are learned to generate the generated data whose label is not determined as the generated class or the black list class by the discriminator.

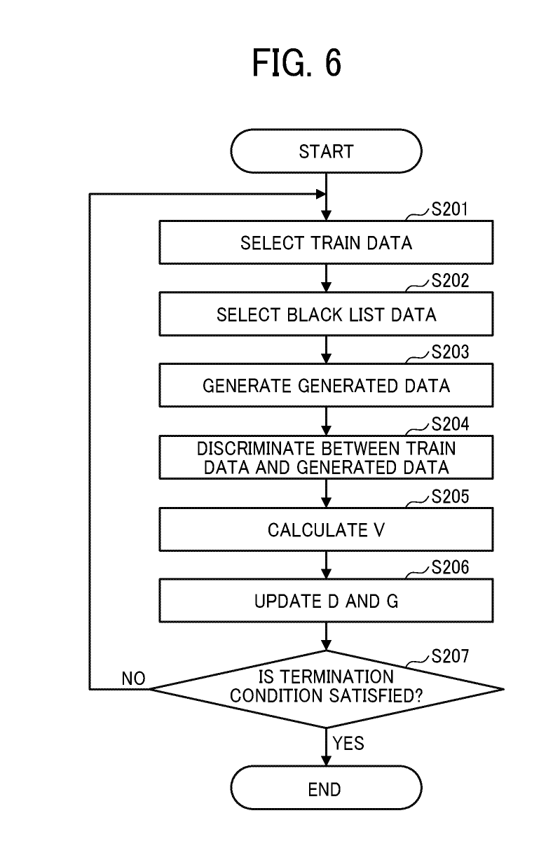

FIG. 6 is a flowchart illustrating a learning process of the second generative model by the second learning unit 17. In the following, it is assumed that the black list data has been added to the data set.

First, the second learning unit 17 selects some or all of the train data included in the data set (step S201). Also, the second learning unit 17 selects some or all of the black list data included in the data set (step S202). Next, the second learning unit 17 generates the generated data by the generator on the basis of the input variable z (step S203). The generated data is input to the discriminator as the input variable x.

Subsequently, the second learning unit 17 discriminates among the train data selected in step S201, the black list data selected in step S202, and the generated data generated in step S203, by the discriminator (step S204). Then, the second learning unit 17 calculates the evaluated value V on the basis of a discrimination result (step S205). After that, the second learning unit 17 updates the parameter groups D and G on the basis of the evaluated value V (step S206).

Afterwards, the second learning unit 17 repeats the processing from step S201 to step S207 until a termination condition is satisfied. The termination condition may be set by the number of times of the learning process, and may be set by the evaluated value V or the evaluated values E of the discriminator and the generator. Also, the termination condition may be set by a ratio of the black list data included in the generated data. When the termination condition is satisfied (YES in step S207), the learning process ends.

As described above, the second learning unit 17 learns the second generative model on the basis of the train data stored in the data set storage 11, the generated data generated by the generator, and the black list data added to the data set by the data set update unit 16.

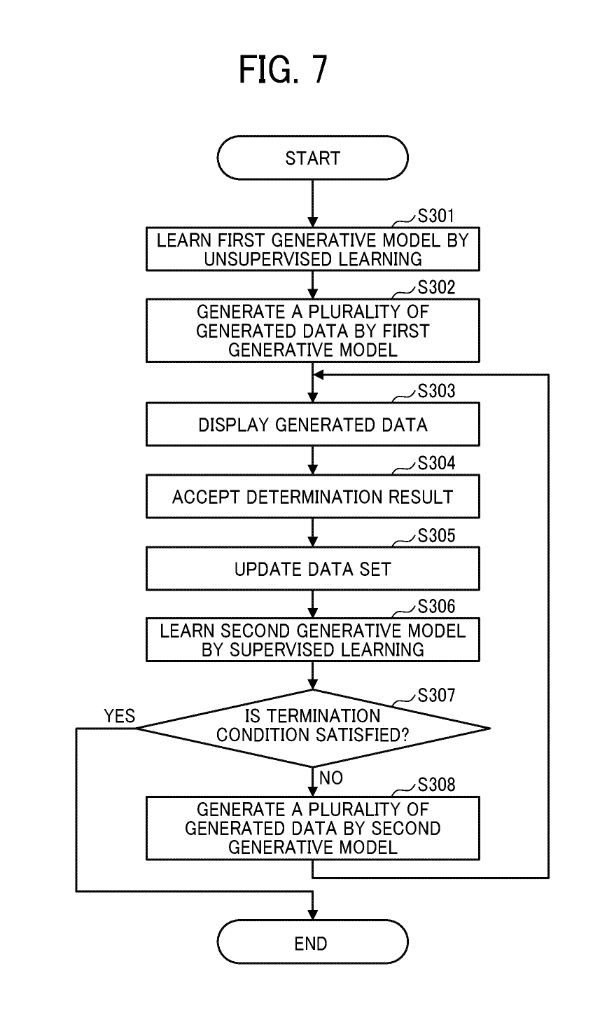

Next, operation of the learning device 1 according to the present embodiment will be described. FIG. 7 is a flowchart illustrating an example of a learning process executed by the learning device 1 according to the present embodiment. In the following, it is assumed that the data set has been stored in the data set storage 11.

First, the first learning unit 12 selects some or all of the train data from the train data included in the data set stored in the data set storage 11, and reads the train data selected. The first learning unit 12 learns the first generative model by unsupervised learning on the basis of the train data read (step S301). A learning method of the first generative model is as described above.

When learning of the first generative model ends, the data generator 13 generates a plurality of generated data by the generator of the first generative model on the basis of the input variable z (step S302).

When the data generator 13 generates the generated data, the data display unit 14 causes the display device 106 to display the plurality of generated data generated (step S303).

When the generated data are displayed, the user determines whether each of the generated data is desirable, and inputs a determination result of each of the generated data to the learning device 1. The determination result acceptance unit 15 accepts the determination result by the user for each of the generated data generated by the first generative model (step S304).

When the determination result acceptance unit 15 accepts the determination result, the data set update unit 16 updates the data set stored in the data set storage 11 on the basis of the determination result (step S305). That is, the data set update unit 16 gives a label of the black list class to the generated data determined as undesirable, and adds the generated data as the black list data to the data set stored in the data set storage 11.

When the black list data is added to the data set, the second learning unit 17 selects some or all of the train data from the train data included in the data set stored in the data set storage 11, and reads the train data selected. Also, the second learning unit 17 selects some or all of the black list data from the Hack list data included in the data set stored in the data set storage 11, and reads the black list data selected. The second learning unit 17 learns the second generative model by supervised learning on the basis of data for learning including the train data and the black list data read (step S306). A learning method of the second generative model is as described above.

After the learning of the second generative model, in a case where a termination condition is satisfied (YES in step S307), the learning process ends. On the other hand, in a case where the termination condition is not satisfied (NO in step S307), the data generator 13 generates a plurality of generated data by the generator of the second generative model learned, on the basis of the input variable z (step S308). After that, the processing returns to step S303, and the data display unit 14 causes the display device 106 to display the plurality of generated data generated (step S303). Afterwards, the learning device 1 repeats the processing from step S303 to step S308 until the termination condition is satisfied.

Incidentally, in a case where the termination condition is set by the ratio of the black list data included in the generated data generated by the generator of the second generative model, the user may confirm the generated data displayed in step S303 and determine whether the termination condition is satisfied. In this case, the user, when determining that the termination condition is satisfied (when determining that the ratio of the black list data is a predetermined threshold value or less), may cause the learning device 1 to end the learning process.

The learning method of the second generative model will be described in more detail.

Generally, in a multilayered neural network, in a case where performance of the multilayered neural network is insufficient, relearning (second and subsequent learning) is executed. As a multilayered neural network relearning method, the following three methods are used.

<First Relearning Method>

A first relearning method is a method of initializing parameters of the multilayered neural network learned, and relearning the parameters from an initial state on the basis of new train data. According to the first relearning method, the multilayered neural network is relearned without depending on an immediately preceding multilayered neural network. For this reason, the first relearning method can also be used in a case where the structure (the number of layers and units) of the multilayered neural network differs before and after relearning. In a case where the performance of the multilayered neural network is insufficient as a result of learning based on inappropriate train data during immediately preceding learning, the multilayered neural network can be effectively relearned by the first relearning method.

<Second Relearning Method>

A second relearning method is a method of using parameters of the multilayered neural network learned as initial values. In the second relearning method, parameters of another multilayered neural network having excellent performance can be used as initial values. For this reason, relearning converges quickly, and can be executed in a short time. Also, the multilayered neural network can be relearned on the basis of the data set that has a small number of samples (train data) and in which learning from an initial state is difficult. However, in the second relearning method, it is required that a part of the multilayered neural network including parameters used as initial values has the same structure before and after relearning.

<Third Relearning Method>

A third relearning method is a method of fixing some of the parameters of the multilayered neural network learned, and relearning only parameters not fixed by the first relearning method or the second relearning method. The third relearning method can reduce the parameters to be relearned, so that relearning can be executed in a short time. In the third relearning method, similarly to the second relearning method, it is required that a part of the multilayered neural network including the parameters to be fixed has the same structure before and after relearning.

In the present embodiment, the first generative model and the second generative model are learned by the first learning unit 12 and the second learning unit 17, respectively. When it is considered that the learning of the first generative model is the first time learning of the multilayered neural network, the learning of the second generative model corresponds to the second time and subsequent relearning of the multilayered neural network. For this reason, the learning of the second generative model is performed by using the first to third relearning methods described above. Hereinafter, six specific examples will be described of a learning method of the discriminator of the second generative model.

<First Learning Method>

A first learning method is a method of initializing all parameters of the discriminator of the second generative model, and learning all parameters from an initial state. The first learning method corresponds to a method for learning all parameters of the discriminator of the second generative model by the first relearning method. For this reason, in a case of using the first learning method, structures of the discriminator of the first generative model and the discriminator of the second generative model may be the same as each other, or may be different from each other.

<Second Learning Method>

In a second learning method, it is a prerequisite that the discriminator of the second generative model includes a common part having the same structure as the discriminator of the first generative model. The common part may be only an input layer, or may be from the input layer up to any one of intermediate layers. A part other than the common part of the discriminator of the second generative model is referred to as a non-common part.

The second learning method is a method of learning at least some parameters of the common part of the discriminator of the second generative model with parameters of the common part of the discriminator of the first generative model as initial values, and learning parameters of another part of the discriminator of the second generative model from an initial state. The second learning method corresponds to a method of learning at least some parameters of the common part of the discriminator of the second generative model by the second relearning method, and learning parameters of another part by the first relearning method.

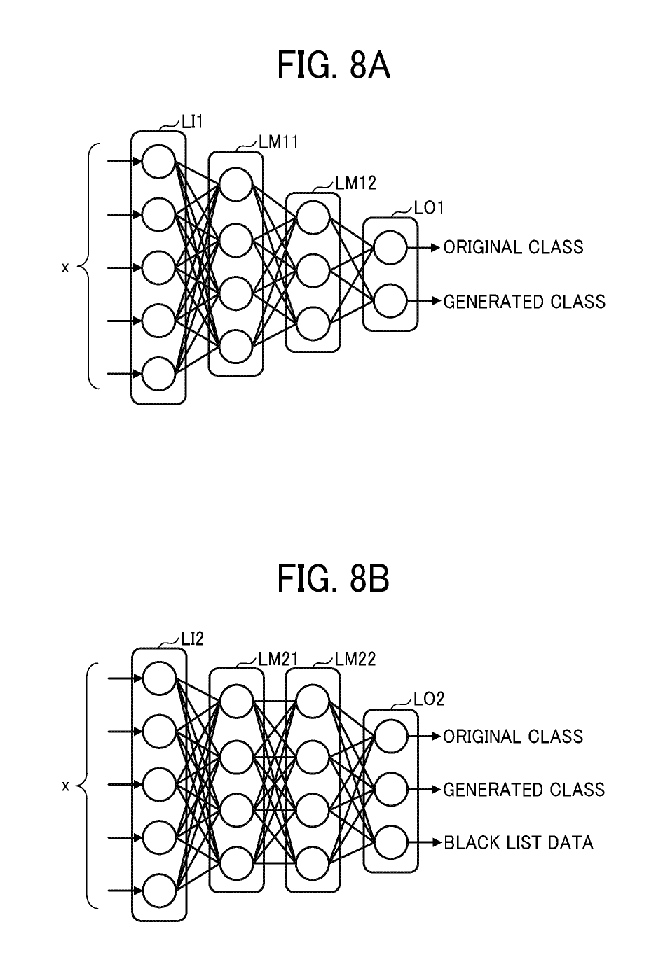

FIG. 8 is a diagram illustrating an example of a structure of each of the discriminators of the first generative model and the second generative model. FIG. 8A illustrates the structure of the discriminator of the first generative model, and FIG. 8B illustrates the structure of the discriminator of the second generative model.

The discriminator of FIG. 8A includes an input layer LI1, a first intermediate layer LM11, a second intermediate layer LM12, and an output layer LO1. The input layer LI1 includes five units, the first intermediate layer LM11 includes four units, the second intermediate layer LM12 includes three units, and the output layer LO1 includes two units. The two units of the output layer LO1 each output a discrimination result (original class or generated class).

The discriminator of FIG. 8B includes an input layer LI2, a first intermediate layer. LM21, a second intermediate layer LM22, and an output layer LO2. The input layer LI2 includes five units, the first intermediate layer LM21 includes four units, the second intermediate layer LM22 includes four units, and the output layer LO2 includes three units. The three units of the output layer LO2 each output a discrimination result (original class, generated class, and black list class).

The discriminator of FIG. 8A and the discriminator of FIG. 8B have the same structures from the input layer up to the first intermediate layer, and have different structures from the second intermediate layer up to the output layer. That is, the common part is from the input layer up to the first intermediate layer, and the non-common part is from the second intermediate layer up to the output layer.

In a case where the discriminator of FIG. 8B is learned by the second learning method, for example, parameters of the input layer LI2 and the first intermediate layer LM21 are learned with parameters of the input layer LI1 and the first intermediate layer LM11 of the discriminator of FIG. 8A as initial values. In this case, parameters of the second intermediate layer LM22 and the output layer LO2 are learned from the initial state.

Parameters of the input layer LI2 may be learned with parameters of the input layer LI1 of the discriminator of FIG. 8A as initial values, and parameters of the first intermediate layer LM21, the second intermediate layer LM22, and the output layer LO2 may be learned from the initial state.

<Third Learning Method>

In a third learning method, similarly to the second learning method, it is a prerequisite that the discriminator of the second generative model includes a common part having the same structure as the discriminator of the first generative model.

The third learning method is a method of fixing at least some parameters of the common part of the discriminator of the second generative model to parameters of the common part of the discriminator of the first generative model, and learning parameters of another part of the discriminator of the second generative model from an initial state. The third learning method corresponds to a method of learning parameters of the discriminator of the second generative model by the third relearning method. In the third learning method, parameters of another part of the discriminator of the second generative model are learned by the second relearning method.

In a case where the discriminator of FIG. 8B is learned by the third learning method, for example, parameters of the input layer LI2 and the first intermediate layer LM21 are fixed to parameters of the input layer LI1 and the first intermediate layer LM11 of the discriminator of FIG. 8A. In this case, parameters of the second intermediate layer LM22 and the output layer LO2 are learned from the initial state.

Parameters of the input layer LI2 may be fixed to parameters of the input layer LI1 of the discriminator of FIG. 8A, and parameters of the first intermediate layer LM21, the second intermediate layer LM22, and the output layer LO2 may be learned from an initial state.

<Fourth Learning Method>

In a fourth learning method, it is a prerequisite that the discriminator of the first generative model and the discriminator of the second generative model each have the same structure. That is, it is a prerequisite that the discriminator of the first generative model includes a unit for discriminating the black list class. Even in a case where the discriminator of the first generative model includes the unit for discriminating the black list class, in learning of the first generative model, the black list data is not used, so that learning about the black list class is not performed. The learning about the black list class is performed during learning of the second generative model.

The fourth learning method is a method of learning all parameters of the discriminator of the second generative model with parameters of the discriminator of the first generative model as initial values. The fourth learning method corresponds to a method of learning all parameters of the discriminator of the second generative model by the second relearning method.

<Fifth Learning Method>

In a fifth learning method, similarly to the fourth learning method, it is a prerequisite that the discriminator of the first generative model and the discriminator of the second generative model each have the same structure.

The fifth learning method is a method of fixing parameters of a first part of the discriminator of the second generative model to parameters of a first part of the discriminator of the first generative model, and learning parameters of a second part of the discriminator of the second generative model from an initial state. The first part can be arbitrarily set, and for example, is from the input layer up to any one of the intermediate layer. The second part is a part other than the first part. The fifth learning method corresponds to a method of learning parameters of the discriminator of the second generative model by the third relearning method. In the fifth learning method, the parameters of the second part of the discriminator of the second generative model are learned by the first relearning method.

<Sixth Learning Method>

In a sixth learning method, similarly to the fourth learning method, it is a prerequisite that the discriminator of the first generative model and the discriminator of the second generative model each have the same structure.

The sixth learning method is a method of fixing the parameters of the first part of the discriminator of the second generative model to the parameters of the first part of the discriminator of the first generative model. The parameters of the second part of the discriminator of the second generative model are learned with parameters of the second part of the discriminator of the first generative model as initial values. The sixth learning method corresponds to a method of learning parameters of the discriminator of the second generative model by the third relearning method. In the sixth learning method, the parameters of the second part of the discriminator of the second generative model are learned by the second relearning method.

In the present embodiment, the generator of the second generative model has the same structure as the generator of the first generative model. Therefore, as the learning method of the generator of the second generative model, any of the above first to sixth learning methods can be used.

As described above, according to the present embodiment, the generator of the second generative model is learned by supervised learning to be able to generate the generated data that cannot be discriminated from the train data by the discriminator. Thus, discrimination accuracy of the discriminator of the second generative model can be improved.

According to the present embodiment, the generator of the second generative model is learned by supervised learning not to generate the generated data similar to the black list data. Thus, generation can be suppressed of the black list data (the generated data determined as undesirable by the user) by the generator of the second generative model.

The learning method according to the present embodiment can be used even in a case where the first generative model and the second generative model are not the deep generative models (that is, in a case where the discriminator and the generator are not the multilayered neural networks). In this case, feature value design by the multilayered neural network is not performed, so that the user may set beforehand the feature values of the first generative model and the second generative model. As the feature values of the first generative model and the second generative model, any known feature values can be set. For example, in a case where the train data is image data, as the feature values of the first generative model and the second generative model, a HoG feature value, a SHIFT feature value, a SURF feature value, or the like can be used. Also, in a case where the train data is audio data, as the feature values of the first generative model and the second generative model, a formant transition feature value or the like can be used.

### Second Embodiment

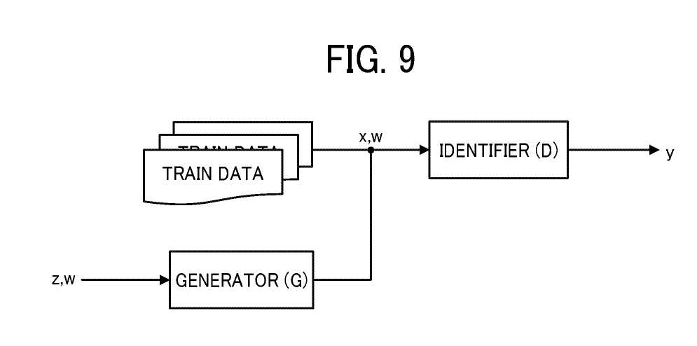

A learning device 1 according to a second embodiment will be described referring to FIGS. 9 to 13. In the present embodiment, a case will be described where a second generative model includes Conditional GAN (CGAN). Other constituents in the present embodiment are similar to those in the first embodiment.

FIG. 9 is a diagram schematically illustrating a configuration of the second generative model (CGAN) in the present embodiment. In FIG. 9, x represents an input variable (train data and generated data) input to the discriminator, and y represents an output variable (original class and generated class) output by the discriminator. Also, z represents an input variable (latent variable) input to the generator, D represents a parameter group included in the discriminator, and G represents a parameter group included in the generator. The parameter groups D and G each include a plurality of parameters.

In FIG. 9, w represents a certainty factor of meta information. The meta information is information indicating identity of the image data given to the generated data by the user. Generally, in a case where the generated data is image data of a person's face, meta information is given to the generated data, such as “smiling”, “feminine”, or “long hair”. The certainty factor w corresponds to certainty of these pieces of meta information.

In the present embodiment, as the meta information, the certainty factor w of “black list class likeness” is given. The “black list class likeness” corresponds to a degree at which the image data is not similar to original data (the certainty determined as undesirable by the user). In a case where there are types in image data determined as undesirable, a plurality of pieces of “black list class likeness” may be prepared.

The discriminator of the second generative model is learned by supervised learning to be able to discriminate whether the input variable x is the train data or the generated data. Specifically, the parameter group D is learned such that the output variable y is the original class in a case where the input variable x is the train data, and the output variable y is the generated class in a case where the input variable x is the generated data.

In contrast, the generator of the second generative model is learned by supervised learning to be able to generate the generated data that cannot be discriminated from the train data by the discriminator, and to be able to generate the generated data having a small certainty factor w. Specifically, the parameter group G is learned such that, in a case where the generated data is input as the input variable x to the discriminator, the output variable y is the original class.

The second learning unit 17 repeats learning described above of the second generative model. Thus, discrimination accuracy of the discriminator improves, and generation accuracy by the generator (degree of similarity of the generated data to the train data) improves. Also, by inputting a small certainty factor w to the generator, the generated data having the small certainty factor w can be generated. That is, generation can be suppressed of the black list data (undesirable generated data). The learning described above of the second generative model is realized by solving the following evaluation function.

$$\begin{matrix}[ Mathematical Equation 3 ] & \\ {min}_{G} {max}_{D} V ( D , G ) = {E}_{x , w \text{\textasciitilde} pdata ( x , w )} [ log D ( x , w ) ] + {E}_{w \text{\textasciitilde} {p}_{w} \cdot z \text{\textasciitilde} pz ( z )} [ log ( 1 - D ( G ( z ) ) ) ] & ( 3 )\end{matrix}$$

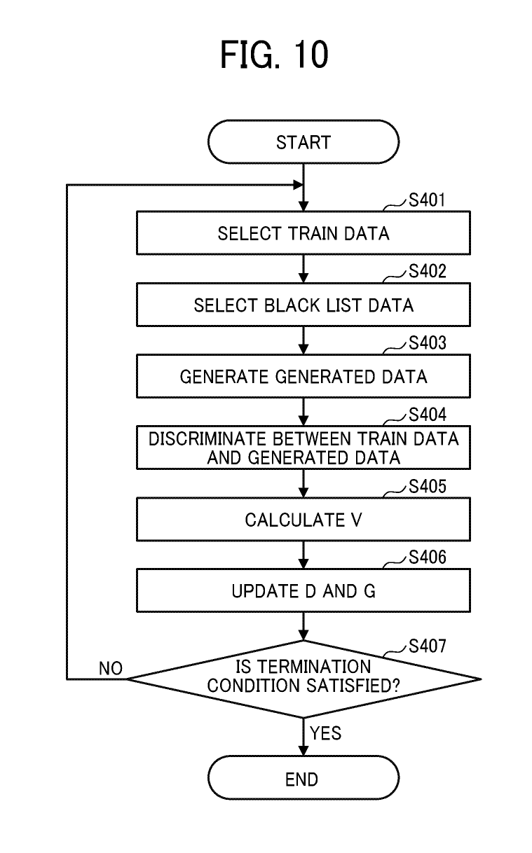

FIG. 10 is a flowchart illustrating a learning process of the second generative model by the second learning unit 17. In the following, it is assumed that the generated data to which the certainty factor w is given (corresponding to the black list data in the first embodiment) has been added to the data set.

First, the second learning unit 17 selects some or all of the train data included in the data set (step S401). Also, the second learning unit 17 selects some or all of the generated data included in the data set (step S402). Next, the second learning unit 17 generates the generated data by the generator such that the certainty factor w is small based on the input variable z (step S403). The generated data is input to the discriminator as the input variable x.

Subsequently, the second learning unit 17 discriminates among the train data selected in step S401, the generated data selected in step S402, and the generated data generated in step S403, by the discriminator (step S404). Then, the second learning unit 17 calculates the evaluated value V based on a discrimination result (step S405). After that, the second learning unit 17 updates the parameter groups D and G based on the evaluated value V (step S406).

Afterwards, the second learning unit 17 repeats the processing from step S401 to step S407 until a termination condition is satisfied. The termination condition may be set by the number of times of the learning process, and may be set by the evaluated value V or the evaluated values E of the discriminator and the generator. Also, the termination condition may be set by a ratio of the black list data (undesirable generated data) included in the generated data. When the termination condition is satisfied (YES in step S407), the learning process ends.

As described above, the second learning unit 17 learns the second generative model based on the train data stored in the data set storage 11, the generated data generated by the generator, and the certainty factor w of the black list class likeness given to the generated data.

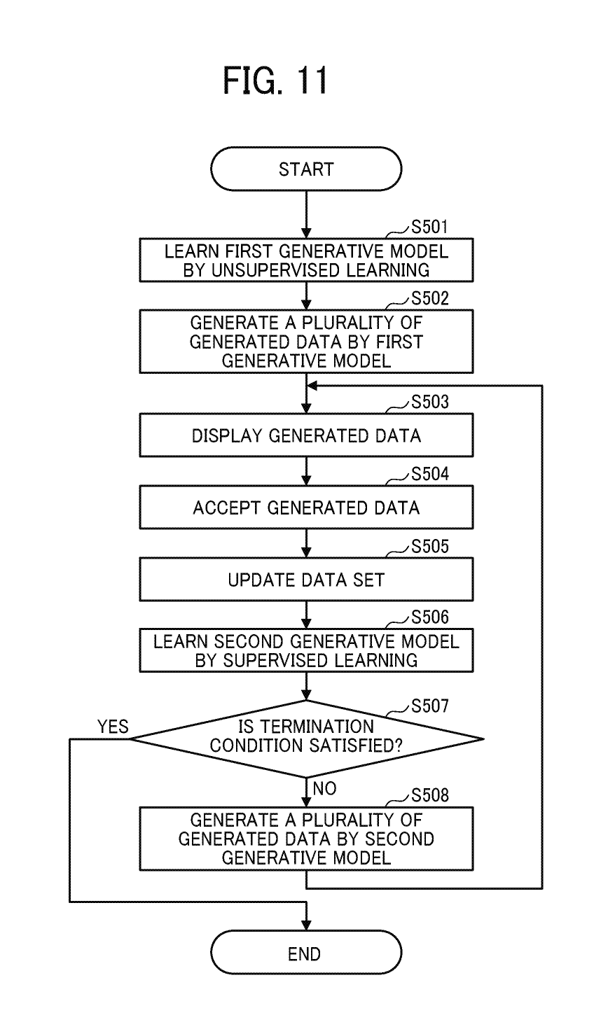

Next, operation of the learning device 1 according to the present embodiment will be described. FIG. 11 is a flowchart illustrating an example of a learning process executed by the learning device 1 according to the present embodiment. In the following, it is assumed that the data set has been stored in the data set storage 11.

First, the first learning unit 12 selects some or all of the train data from the train data included in the data set stored in the data set storage 11, and reads the train data selected. The first learning unit 12 learns the first generative model by unsupervised learning based on the train data read (step S501). A learning method of the first generative model is similar to the first embodiment.

When learning of the first generative model ends, the data generator 13 generates a plurality of generated data by the generator of the first generative model based on the input variable z (step S502).

When the data generator 13 generates the generated data, the data display unit 14 causes the display device 106 to display the plurality of generated data generated (step S503).

When the generated data are displayed, the user gives the certainty factor w of the black list class likeness to each of the generated data. The user may give a larger certainty factor w as the generated data is more undesirable, and a smaller certainty factor w as the generated data is more desirable. The user inputs the generated data to which the certainty factor w is given, to the learning device 1. The determination result acceptance unit 15 accepts each of the generated data to which the certainty factor w is given (step S504).

When the determination result acceptance unit 15 accepts the generated data, the data set update unit 16 updates the data set stored in the data set storage 11 (step S505). That is, the data set update unit 16 adds the generated data to which the certainty factor w is given, to the data set stored in the data set storage 11.

When the generated data to which the certainty factor w is given is added to the data set, the second learning unit 17 selects some or all of the train data from the train data included in the data set stored in the data set storage 11, and reads the train data selected. Also, the second learning unit 17 selects some or all of the generated data from the generated data included in the data set stored in the data set storage 11, and reads the generated data selected. The second learning unit 17 learns the second generative model by supervised learning on the basis of data for learning including the train data and the generated data read (teacher data) (step S506). A learning method of the second generative model is as described above.

After the learning of the second generative model, in a case where the termination condition is satisfied (YES in step S507), the learning process ends. On the other hand, in a case where the termination condition is not satisfied (NO in step S507), the data generator 13 generates a plurality of generated data by the generator of the second generative model learned, on the basis of the input variable z (step S508). After that, the processing returns to step S503, and the data display unit 14 causes the display device 106 to display the plurality of generated data generated (step S503). Afterwards, the learning device 1 repeats the processing from step S503 to step S508 until the termination condition is satisfied.

Incidentally, in a case where the termination condition is set by the ratio of the Hack list data included in the generated data generated by the generator of the second generative model, the user may confirm the generated data displayed in step S503 and determine whether the termination condition is satisfied. In this case, the user, when determining that the termination condition is satisfied (when determining that the ratio of the black list data is a predetermined threshold value or less), may cause the learning device 1 to end the learning process.

The learning method of the second generative model will be described in more detail. In the present embodiment, the first generative model and the second generative model are learned by the first learning unit 12 and the second learning unit 17, respectively. When it is considered that the learning of the first generative model is the first time learning of the multilayered neural network, the learning of the second generative model corresponds to the second time and subsequent relearning of the multilayered neural network. For this reason, the learning of the second generative model is performed by using the first to third relearning methods described above.

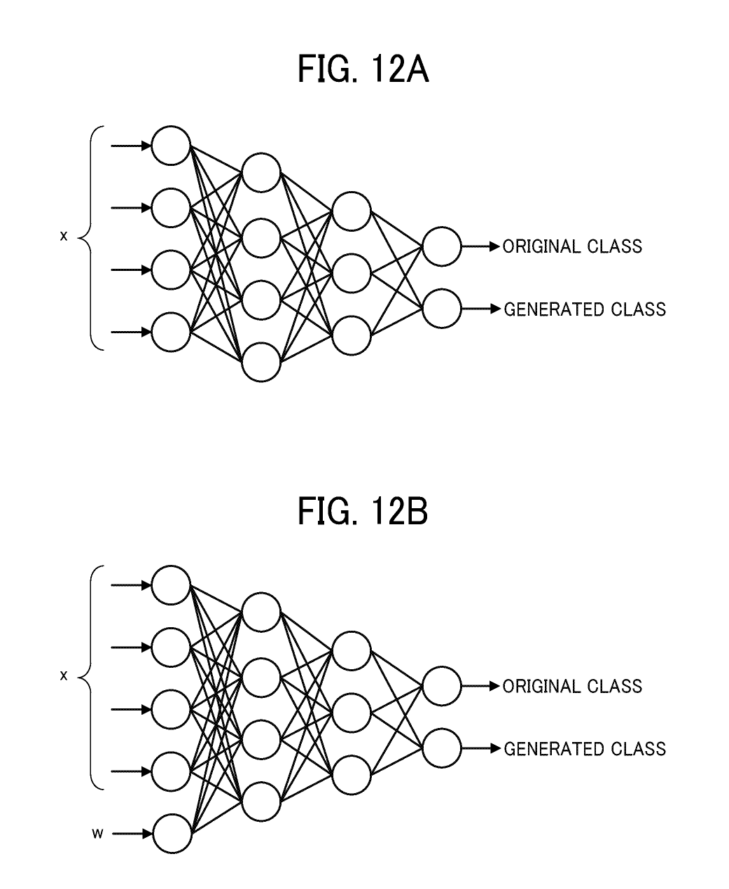

FIG. 12 is a diagram illustrating an example of a structure of each of the discriminators of the first generative model and the second generative model. FIG. 12A illustrates the structure of the discriminator of the first generative model, and FIG. 12B illustrates the structure of the discriminator of the second generative model. As can be seen from FIG. 12, the discriminators of the first generative model and the second generative model have structures different from each other. Specifically, the input layer of the discriminator of the second generative model is obtained by adding a unit for inputting the certainty factor w to the input layer of the discriminator of the first generative model. In this way, in a case where the structures of the first generative model and the second generative model are different from each other, the discriminator of the second generative model may be learned using any of the first learning method to the sixth learning method described in the first embodiment.

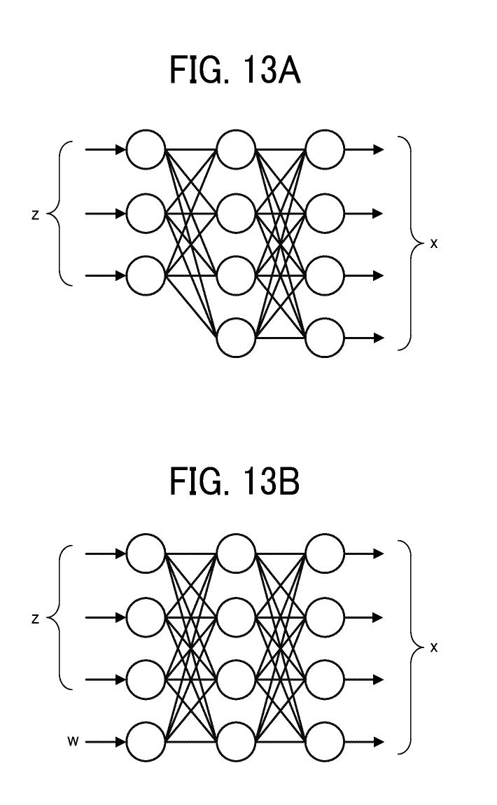

FIG. 13 is a diagram illustrating an example of a structure of each of the generators of the first generative model and the second generative model. FIG. 13A illustrates the structure of the generator of the first generative model, and FIG. 13B illustrates the structure of the generator of the second generative model. As can be seen from FIG. 13, the generators of the first generative model and the second generative model have structures different from each other. Specifically, the input layer of the generator of the second generative model is obtained by adding a unit for inputting the certainty factor w to the input layer of the generator of the first generative model. In this way, in a case where the structures of the first generative model and the second generative model are different from each other, the generator of the second generative model may be learned using any of the first learning method to the sixth learning method described in the first embodiment.

As described above, according to the present embodiment, the generator of the second generative model is learned by supervised learning to be able to generate the generated data that cannot be discriminated from the train data by the discriminator. Thus, discrimination accuracy of the discriminator of the second generative model can be improved.

According to the present embodiment, the generator of the second generative model is learned by supervised learning to generate the generated data having a small certainty factor w of the Hack list likeness. Thus, generation can be suppressed of the black list data (undesirable generated data) by the generator of the second generative model.

According to the present embodiment, the second generative model is the CGAN, so that not only whether the generated data is desirable, but also the type and degree of desirability can be learned. Thus, the user can specify the undesirable generated data in more detail, and suppress generation of the undesirable generated data.

According to the embodiments of the present invention, generation can be suppressed of the data undesirable for the user by the generative model. The undesirable data for the user include, for example, image data having uneven texture, and image data ignoring a stereoscopic shape generated by a deep generative model generating image data.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DST), field programmable gate array (FPGA), and conventional circuit components arranged to perform the recited functions.

1. A generative model learning method comprising:
learning a first generative model by unsupervised learning based on train data prepared beforehand;
generating generated data by the first generative model; and
learning a second generative model by supervised learning based on the train data and the generated data determined as undesirable by a user.

2. The generative model learning method according to claim 1, wherein
the first generative model and the second generative model are generative adversarial networks each including a generator configured to generate the generated data, and a discriminator configured to discriminate between the generated data and the train data.

3. The generative model learning method according to claim 2, wherein
the generator and the discriminator each include a multilayered neural network.

4. The generative model learning method according to claim 2, wherein
the learning the second generative model includes learning all parameters of the discriminator of the second generative model from an initial state.

5. The generative model learning method according to claim 2, wherein
the discriminator of the first generative model and the discriminator of the second generative model each include a common part having an identical structure, and
the learning the second generative model includes:
learning at least some parameters of the common part of the discriminator of the second generative model with parameters of the common part of the discriminator of the first generative model as initial values; and
learning parameters of another part of the discriminator of the second generative model from an initial state.

6. The generative model learning method according to claim 2, wherein
the discriminator of the first generative model and the discriminator of the second generative model each include a common part having an identical structure, and
the learning the second generative model includes:
fixing at least some parameters of the common part of the discriminator of the second generative model to parameters of another part of the discriminator of the first generative model; and
learning parameters of a non-common part of the discriminator of the second generative model from an initial state.

7. The generative model learning method according to claim 2, wherein
the discriminator of the first generative model and the discriminator of the second generative model have an identical configuration, and
the learning the second generative model includes learning parameters of the discriminator of the second generative model with parameters of the discriminator of the first generative model as initial values.

8. The generative model learning method according to claim 2, wherein
the discriminator of the first generative model and the discriminator of the second generative model have an identical configuration, and
the learning the second generative model includes:
fixing parameters of a first part of the discriminator of the second generative model to parameters of the first part of the discriminator of the first generative model; and
learning parameters of a second part of the discriminator of the second generative model from an initial state.

9. The generative model learning method according to claim 2, wherein
the discriminator of the first generative model and the discriminator of the second generative model have an identical configuration, and
the learning the second generative model includes:
fixing parameters of a first part of the discriminator of the second generative model to parameters of the first part of the discriminator of the first generative model; and
learning parameters of a second part of the discriminator of the second generative model with parameters of the second part of the discriminator of the first generative model as initial values.

10. The generative model learning method according to claim 3, wherein
the learning the second generative model includes learning all parameters of the discriminator of the second generative model from an initial state.

11. The generative model learning method according to claim 3, wherein
the discriminator of the first generative model and the discriminator of the second generative model each include a common part having an identical structure, and
the learning the second generative model includes:
learning at least some parameters of the common part of the discriminator of the second generative model with parameters of the common part of the discriminator of the first generative model as initial values; and
learning parameters of another part of the discriminator of the second generative model from an initial state.

12. The generative model learning method according to claim 3, wherein
the discriminator of the first generative model and the discriminator of the second generative model each include a common part having an identical structure, and
the learning the second generative model includes:
fixing at least some parameters of the common part of the discriminator of the second generative model to parameters of another part of the discriminator of the first generative model; and
learning parameters of a non-common part of the discriminator of the second generative model from an initial state.

13. The generative model learning method according to claim 3, wherein
the discriminator of the first generative model and the discriminator of the second generative model have an identical configuration, and
the learning the second generative model includes learning parameters of the discriminator of the second generative model with parameters of the discriminator of the first generative model as initial values.

14. The generative model learning method according to claim 1, wherein
the first generative model is a deep convolutional generative adversarial networks (DCGAN).

15. The generative model learning method according to claim 1, wherein
the second generative model is a blacklist DCGAN.

16. The generative model learning method according to claim 1, wherein
the second generative model is a conditional GAN.

17. A system for learning generative model, comprising:
one or more processors; and
one or memories to store a plurality of instructions which, when executed by the one or more processors, cause the processors to:
learn a first generative model by unsupervised learning based on train data prepared beforehand;
generate generated data by the first generative model; and
learn a second generative model by supervised learning based on the train data and the generated data determined as undesirable by a user.

18. A computer program product comprising a computer useable medium including a computer-readable program, wherein the computer-readable program when executed on a computer causes the computer to perform a generative model learning method comprising:
learning a first generative model by unsupervised learning based on train data prepared beforehand;
generating generated data by the first generative model; and
learning a second generative model by supervised learning based on the train data and the generated data determined as undesirable by a user.
